(19) United States
(12) Patent Application Publication
(10) Pub. No.: US 2016/0179726 A1
(43) Pub. Date: Jun. 23, 2016

(54) PROGRAMMING HARDWARE REGISTERS USING A PIPELINED REGISTER BUS, AND RELATED METHODS, SYSTEMS, AND APPARATUSES

(71) Applicant: QUALCOMM Incorporated, San Diego, CA (US)

(72) Inventors: Chi-Wen Chang, Cupertino, CA (US); Yi-Pin Hsiao, San Diego, CA (US); Praveen Mandava, San Jose, CA (US); Vickie Youmin Wu, Cupertino, CA (US); Adam Andrew Zerwick, San Jose, CA (US)

(21) Appl. No.: 14/573,328

(22) Filed: Dec. 17, 2014

(51) Int. Cl. G06F 13/40; G06F 13/42; G06F 13/364

(52) U.S. Cl. CPC G06F 13/404; G06F 13/364; G06F 13/4282; G06F 13/4022

(57) ABSTRACT

Programming hardware registers using a pipelined register bus, and related methods, systems, and apparatuses are disclosed. In one aspect, a method for communicating over a register bus comprises initiating, at a register bus master, a request comprising an address, and passing the request from the register bus master to a first register bus slave of a processor module via a register bus. The method further comprises decoding the address at a module core of the processor module, and determining whether the address corresponds to the processor module. The method also comprises, responsive to determining that the address corresponds to the processor module, processing the request by the module core, and passing the same request as-is to a second register bus slave. The method additionally comprises, responsive to determining that the address does not correspond to the processor module, passing the same request as-is to the second register bus slave.

### BACKGROUND

I. Field of the Disclosure

The technology of the disclosure relates generally to reading and writing hardware registers via a register bus.

II. Background

Modern computer processors make use of a variety of bus standards and mechanisms to provide connectivity among master devices and between master devices and slave devices. One type of bus standard provides a register bus, which may be used by computer instructions executing on a processor to program hardware registers (for example, reading or writing a hardware register to place a processor module in a desired configuration). Requests to program a hardware register may be received by a register bus master, which is then responsible for routing the request via the register bus to the appropriate hardware register.

However, as more recent processors incorporate greater numbers of hardware registers, the register bus may be required to handle a corresponding increased bus load. To cope with timing issues that may be introduced by an increased bus load, some conventional processors may operate the register bus at a clock frequency lower than a clock frequency of a data bus. However, using a lower clock frequency for the register bus may increase overheads associated with clock domain crossing. For instance, Design for Test (DFT) insertions may be complicated by clock domain crossing, which may result in additional testing time required to validate a hardware design. Additionally, some operations such as dynamic reading of data may require additional logic, and may necessitate more complicated timing constraints.

Another conventional solution for handling an increased load on the register bus is to centralize the hardware registers at a single register bus slave connected to the register bus master. By doing so, the register bus may be operated at the higher clock frequency of the data bus. However, under this approach, associating the centralized hardware registers with distributed processor modules may require that input/output (I/O) ports for each processor module be non-uniform and module-specific. Further, such an approach may require additional routing area due to hierarchical partitioning.

### SUMMARY OF THE DISCLOSURE

Aspects disclosed in the detailed description include programming hardware registers using a pipelined register bus. Related methods, systems, and apparatuses are also disclosed. In this regard, in some aspects, a register bus may connect a register bus master and one or more register bus slaves. In exemplary aspects, each register bus slave may be associated with a processor module including a module core and one or more programmable hardware registers. The register bus master sends a request (e.g., to program a hardware register) including an address to a first register bus slave via the register bus. The module core of the processor module associated with the first register bus slave decodes the address, and determines whether the address corresponds to the processor module (by, e.g., determining whether the address is contained within an address space assigned to the processor module). If so, the request is processed by the module core, and the same request is passed on as-is by the first register bus slave to the second register bus slave. If the address does not correspond to the processor module, the first register bus slave passes the same request as-is to the second register bus slave. In this manner, programming of the hardware register may be temporally spread across module cores, which may enable the register bus to operate at the higher clock frequency of a data bus while providing a uniform module input/output interface. In some aspects, the register bus master and the register bus slaves may be arranged in a daisy chain configuration. According to some aspects, if the request is a write request, the first register bus slave does not pass any data onto the register bus. If the request is a read request, the first register bus slave may pass the requested data along with a data validity signal onto the register bus. In the latter case, the requested data may be passed to the second register bus slave in conjunction with the request, or may be sent subsequent to passing the requested data to the second register bus slave.

In another aspect, a method for communicating over a register bus is provided. The method comprises initiating, at a register bus master, a request comprising an address. The method further comprises passing the request from the register bus master to a first register bus slave of a processor module via a register bus. The method additionally comprises decoding the address at a module core of the processor module. The method also comprises determining whether the address corresponds to the processor module. The method further comprises, responsive to determining that the address corresponds to the processor module, processing the request by the module core, and passing the same request as-is by the first register bus slave to a second register bus slave. The method additionally comprises, responsive to determining that the address does not correspond to the processor module, passing the same request as-is by the first register bus slave to the second register bus slave.

In another aspect, a system for communicating over a register bus is provided. The system comprises a register bus communicatively coupling a register bus master to a first register bus slave of a processor module, and further communicatively coupling the first register bus slave to a second register bus slave. The register bus master is configured to initiate a request comprising an address, and to pass the request to the first register bus slave of the processor module via the register bus. The processor module is configured to decode the address at a module core of the processor module, and determine whether the address corresponds to the processor module. The processor module is further configured to, responsive to determining that the address corresponds to the processor module, process the request by the module core. The first register bus slave is configured to pass the same request as-is by the first register bus slave to the second register bus slave via the register bus.

In another aspect, an apparatus comprising a register slave device on a register bus is provided. The register slave device comprises a first bus interface configured to receive a request from a register bus. The register slave device further comprises an address decoder communicatively coupled to the first bus interface. The address decoder is configured to extract an address from the request, and decode the address. The register slave device further comprises a second bus interface communicatively coupled to the first bus interface. The second bus interface is configured to pass the request from the first bus interface back to the register bus. The register slave device additionally comprises a module core communicatively coupled to the first bus interface and configured to process the request.

In another aspect, a method of operating a register slave device is provided. The method comprises receiving, at a register slave device, a first clock signal. The method further comprises receiving a request at a first bus interface of the register slave device via a register bus at a first clock cycle, the request comprising an address. The method additionally comprises passing the request to a second bus interface of the register slave device at a second clock cycle. The method also comprises returning the request to the register bus at a third clock cycle after the second clock cycle. The method further comprises decoding the address, and determining whether the address corresponds to the register slave device. The method additionally comprises, responsive to determining that the address corresponds to the register slave device, processing the request in a module core of the register slave device, and providing data to the register bus from the module core at a subsequent fourth clock cycle.

### BRIEF DESCRIPTION OF THE FIGURES

FIG. 1 is a simplified view of a computing device that may include a pipelined register bus;

FIG. 2 is a perspective view of a mobile terminal that may include a pipelined register bus;

FIG. 3 is a block diagram of components of the mobile terminal of FIG. 2;

FIG. 4 is a block diagram illustrating an exemplary pipelined register bus topology including a register bus master and processor modules comprising module cores and register bus slaves;

FIGS. 5A-5C are block diagrams illustrating exemplary communications flows among a processor module and a register bus slave of FIG. 4 using a pipelined register bus; and

FIG. 6 is a flowchart illustrating an exemplary process for communicating over the pipelined register bus of FIG. 4.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. It is to be understood that, although the terms “first,” “second,” and so on may be used herein to describe various elements, these elements should not be limited by these terms. These terms are used only to distinguish one element from another. For example, a first device may be referred to as a second device, and, similarly, a second device may be referred to as a first device, without departing from the teachings of the disclosure.

Aspects disclosed in the detailed description include programming hardware registers using a pipelined register bus. Related methods, systems, and apparatuses are also disclosed. In this regard, in some aspects, a register bus may connect a register bus master and one or more register bus slaves. In exemplary aspects, each register bus slave may be associated with a processor module including a module core and one or more programmable hardware registers. The register bus master sends a request (e.g., to program a hardware register) including an address to a first register bus slave via the register bus. The module core of the processor module associated with the first register bus slave decodes the address, and determines whether the address corresponds to the processor module (by, e.g., determining whether the address is contained within an address space assigned to the processor module). If so, the request is processed by the module core, and the same request is passed on as-is by the first register bus slave to the second register bus slave. If the address does not correspond to the processor module, the first register bus slave passes the same request as-is to the second register bus slave. In this manner, programming of the hardware register may be temporally spread across module cores, which may enable the register bus to operate at the higher clock frequency of a data bus while providing a uniform module input/output interface. In some aspects, the register bus master and the register bus slaves may be arranged in a daisy chain configuration. According to some aspects, if the request is a write request, the first register bus slave does not pass any data onto the register bus. If the request is a read request, the first register bus slave may pass the requested data along with a data validity signal onto the register bus. In the latter case, the requested data may be passed to the second register bus slave in conjunction with the request, or may be sent subsequent to passing the requested data to the second register bus slave.

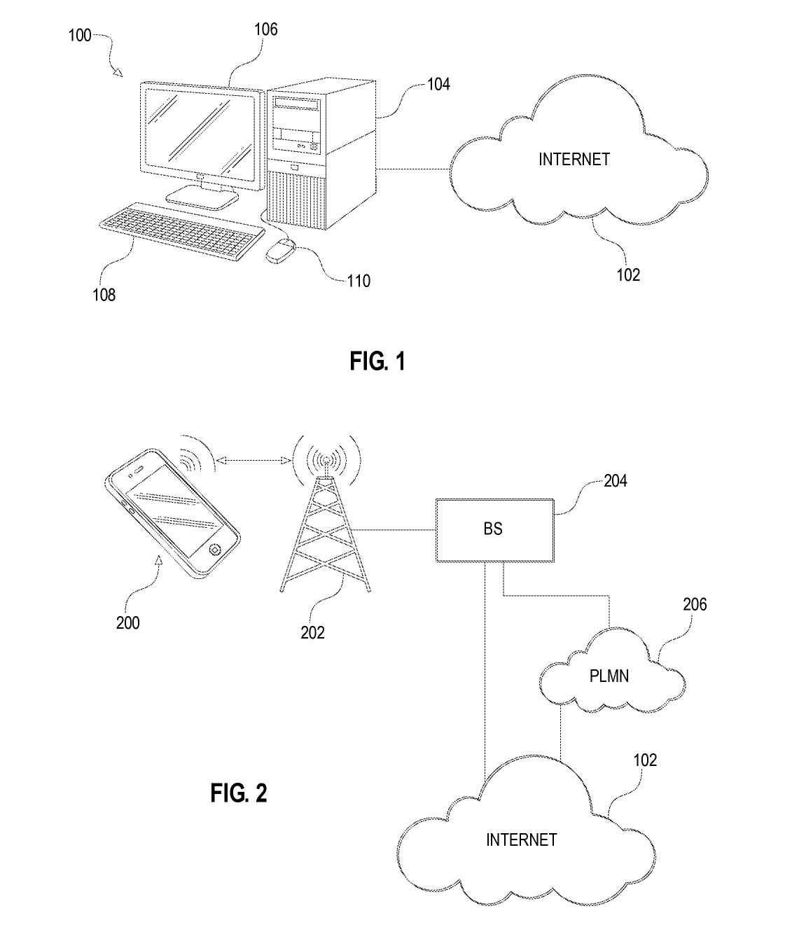

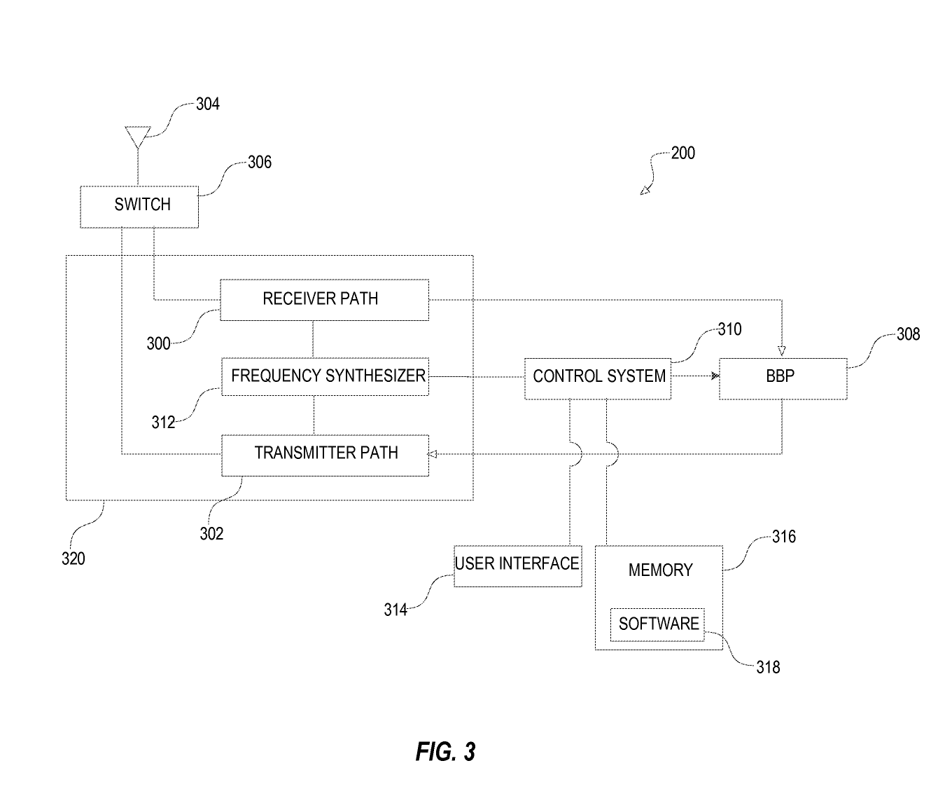

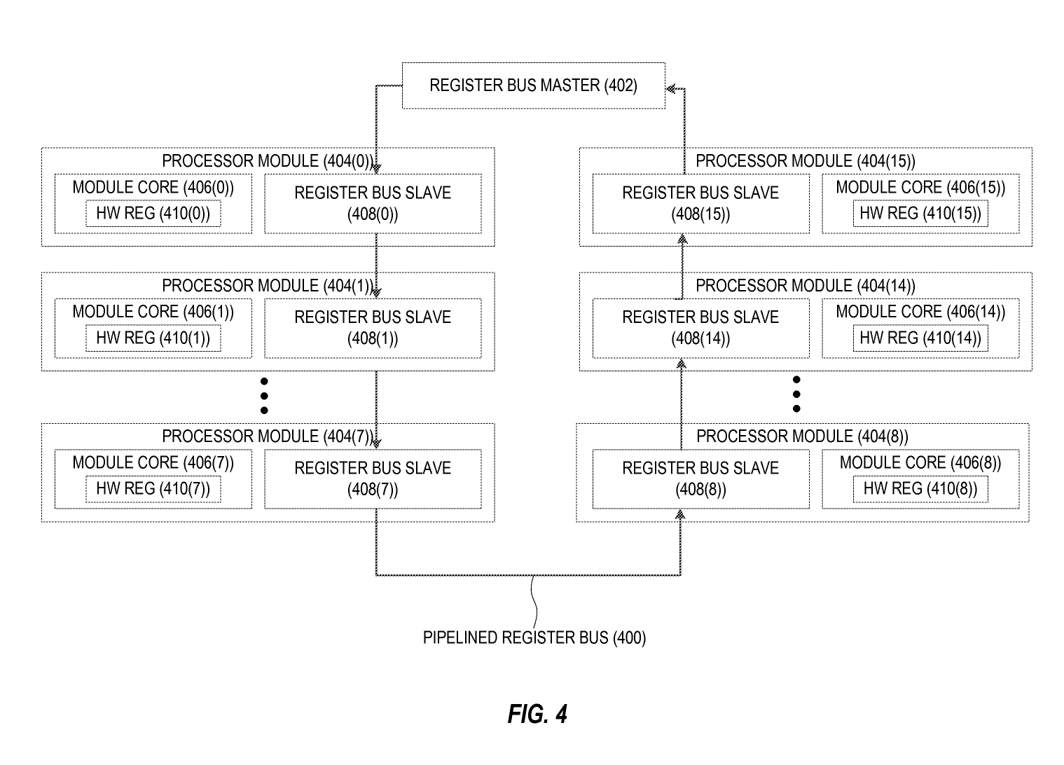

Before discussing programming hardware registers using a pipelined register bus, exemplary devices in which aspects of the present disclosure may be implemented are first described with reference to FIGS. 1-3. FIGS. 1 and 2 illustrate a computing device and a mobile terminal, respectively, while FIG. 3 illustrates components of FIG. 2 in greater detail. Exemplary aspects of the present disclosure are then discussed beginning with FIG. 4 below.

While an exemplary aspect of the present disclosure contemplates implementation in a mobile terminal, such as a cellular phone, the present disclosure is not so limited. In this regard, FIG. 1 illustrates a computing device 100 coupled to a network 102, which, in an exemplary aspect, is the internet. The computing device 100 may include a housing 104 with a central processing unit (CPU) (not shown) therein. A user (not shown) may interact with the computing device 100 through a user interface formed from input/output elements, such as a monitor (sometimes referred to as a display) 106, a keyboard 108, and/or a mouse 110. In some aspects, the monitor 106 may be incorporated into the housing 104. While the keyboard 108 and the mouse 110 are illustrated, the monitor 106 in some aspects may be a touchscreen display, which may supplement or replace the keyboard 108 and/or the mouse 110. Other input/output devices may also be present as is well understood in conjunction with desktop- or laptop-style computing devices.

In addition to the computing device 100, the exemplary aspects of the present disclosure may also be implemented on mobile computing devices. In this regard, an exemplary aspect of a mobile terminal 200 is illustrated in FIG. 2. The mobile terminal 200 may be a smart phone, such as a SAMSUNG GALAXY™ or APPLE iPHONE®. Instead of a smart phone, the mobile terminal 200 may be a cellular telephone, a tablet, a laptop, or other mobile computing device. The mobile terminal 200 may communicate with a remote antenna 202 associated with a base station (BS) 204. The BS 204 may communicate with a public land mobile network (PLMN) 206, a public switched telephone network (PSTN) (not shown), or a network 102 (e.g., the internet). The PLMN 206 may communicate with the internet (e.g., the network 102) either directly or through an intervening network. It should be appreciated that most contemporary mobile terminals 200 allow for various types of communication with elements of the network 102. As non-limiting examples, streaming audio, streaming video, and/or web browsing are all common functions on most contemporary mobile terminals 200. Such functions are enabled through applications stored in memory of the mobile terminal 200 and by using a wireless transceiver of the mobile terminal 200.

A more detailed depiction of the components of the mobile terminal 200 of FIG. 2 is provided with reference to FIG. 3. In this regard, a block diagram of some of the elements of the mobile terminal 200 is illustrated. The mobile terminal 200 may include a receiver path 300, a transmitter path 302, an antenna 304, a switch 306, a baseband processor (BBP) 308, a control system 310, a frequency synthesizer 312, a user interface 314, and memory 316 with software 318 stored therein.

The receiver path 300 receives information-bearing radio frequency (RF) signals from one or more remote transmitters provided by the BS 204 of FIG. 2. A low noise amplifier (not shown) amplifies the signal. A filter (not shown) minimizes broadband interference in the received signal, while down-conversion and digitization circuitry (not shown) down-converts the filtered, received signal to an intermediate or baseband frequency signal, which is then digitized into one or more digital streams. The receiver path 300 typically uses one or more mixing frequencies generated by the frequency synthesizer 312. The BBP 308 processes the digitized received signal to extract the information or data bits conveyed in the signal. As such, the BBP 308 is typically implemented in one or more digital signal processors (DSPs).

With continued reference to FIG. 3, on the transmit side, the BBP 308 receives digitized data representing voice, data, or control information, as non-limiting examples, from the control system 310. The BBP 308 encodes the digitized data for transmission and outputs the encoded data to the transmitter path 302, where it is used by a modulator (not shown) to modulate a carrier signal at a desired transmit frequency. An RF power amplifier (not shown) amplifies the modulated carrier signal to a level appropriate for transmission, and delivers the amplified and modulated carrier signal to the antenna 304 through the switch 306. Collectively, the receiver path 300, the transmitter path 302, and the frequency synthesizer 312 may be considered to be a wireless modem 320.

With continued reference to FIG. 3, a user may interact with the mobile terminal 200 via the user interface 314, such as via a microphone, a speaker, a keypad, and/or a display, as non-limiting examples. Audio information encoded in the received signal is recovered by the BBP 308, and converted into an analog signal suitable for driving the speaker. The keypad and display enable the user to interact with the mobile terminal 200. For example, the keypad and display may enable the user to input numbers to be dialed, access address book information, or the like, as well as monitor call progress information. The memory 316 may have the software 318 therein as noted above, which may generate requests to be processed by exemplary aspects of the present disclosure. While not illustrated, it is to be understood that a less mobile computing device 100 may have similar elements, but instead of the wireless modem 320, the computing device 100 may provide a network interface controller (NIC) having a wire-based interface to effectuate communications.

One or more of the components illustrated in FIG. 3 may comprise a plurality of processor modules, each including one or more programmable hardware registers and connected by a register bus. To enable the register bus to operate at a higher clock frequency (e.g., the clock frequency of a data bus) while supporting uniform processor module input/output (I/O) ports, a pipelined register bus may be provided. In this regard, FIG. 4 illustrates a pipelined register bus 400 topology according to some aspects disclosed herein. In FIG. 4, the pipelined register bus 400 communicatively couples a register bus master 402 with one or more processor modules 404(0)-404(15).

Each of the processor modules 404(0)-404(15) may represent a discrete processing element responsible for implementing a particular processing functionality. As a non-limiting example, each of the processor modules 404(0)-404(15) may be a functional element of an image signal processor (ISP). It is to be understood that FIG. 4 shows a total of 16 processor modules 404(0)-404(15) for illustrative purposes only, and that some aspects of the pipelined register bus 400 topology disclosed herein may include more or fewer processor modules 404(0)-404(15). Because the processor modules 404(0)-404(15) receive and respond to requests from the register bus master 402, the processor modules 404(0)-404(15) may be referred to herein as “register slave devices 404(0)-404(15).”

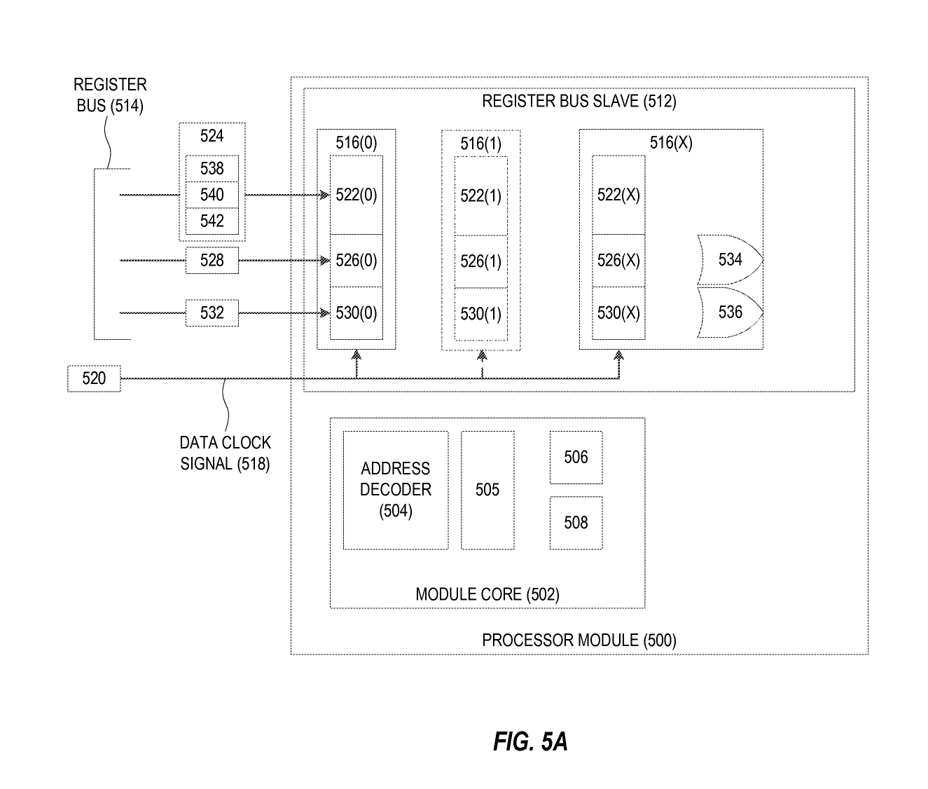

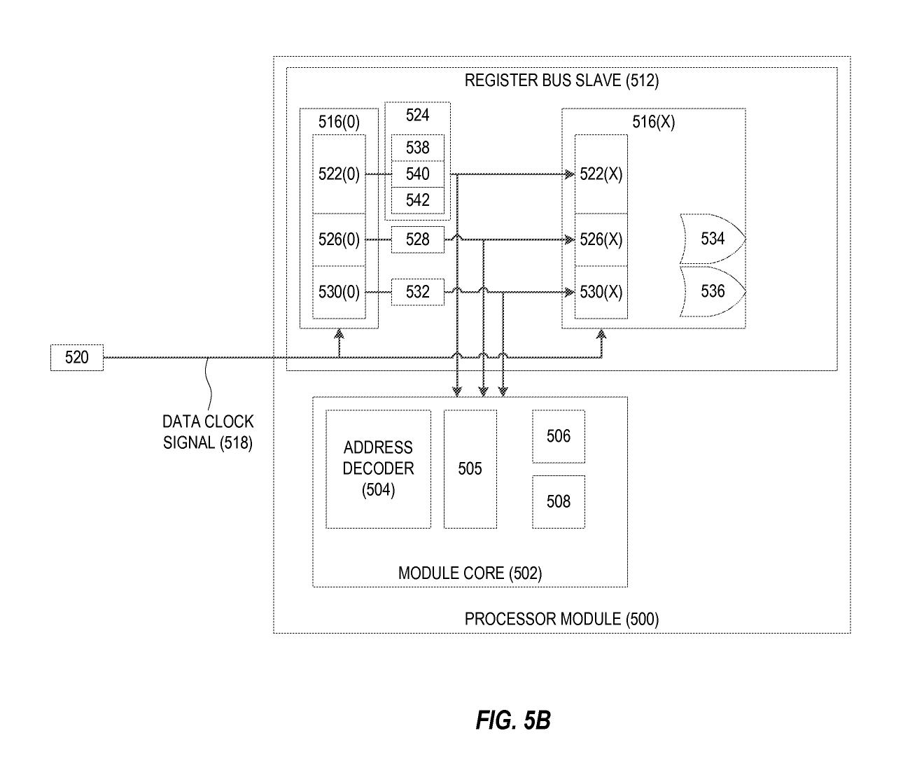

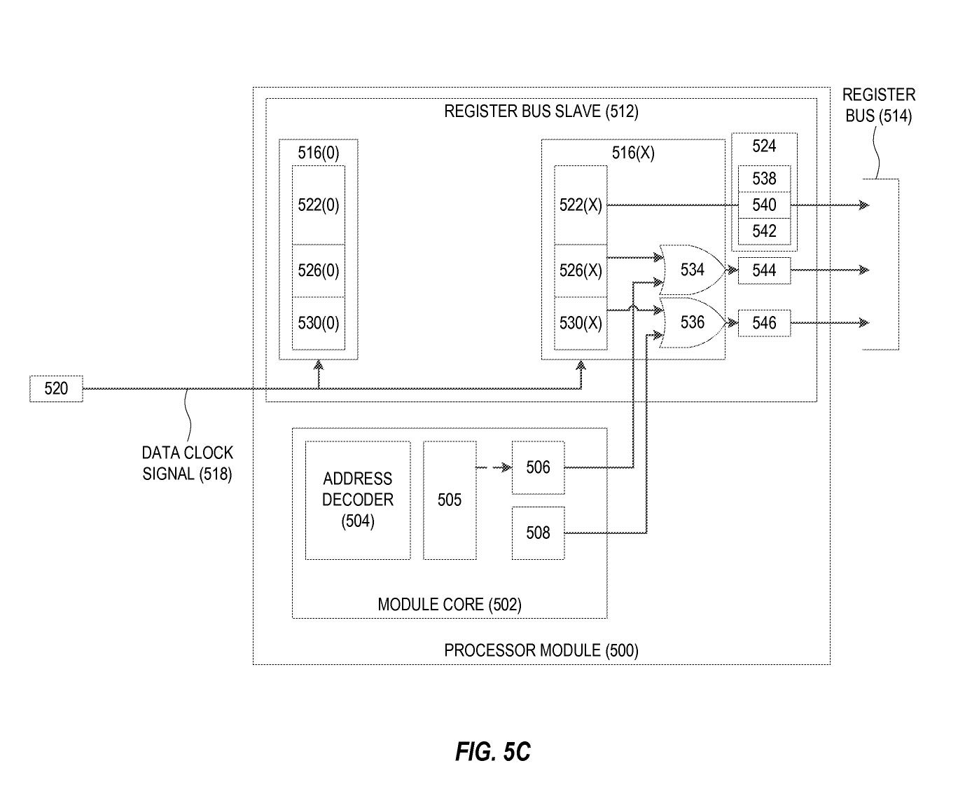

The processor modules 404(0)-404(15) comprise respective module cores 406(0)-406(15) and register bus slaves 408(0)-408(15). The module cores 406(0)-406(15) perform processing tasks for the corresponding processor modules 404(0)-404(15), including address decoding and hardware register read and/or writes, as non-limiting examples. Accordingly, as discussed in greater detail below with respect to FIGS. 5A-5C, the module cores 406(0)-406(15) may include elements such as an address decoder (not shown) and one or more hardware registers 410(0)-410(15), as non-limiting examples. The register bus slaves 408(0)-408(15) are elements of the corresponding processor modules 404(0)-404(15) that receive and forward communications (e.g., requests for hardware register reads and/or writes) via the pipelined register bus 400.

In some aspects, the pipelined register bus 400 connects the register bus master 402 and the register bus slaves 408(0)-408(15) in a daisy chain configuration. For instance, in the example of FIG. 4, the register bus master 402 is connected to the register bus slave 408(0), which in turn is connected to the register bus slave 408(1), and so on. The last register bus slave 408(15) is then connected to the register bus master 402, thus completing the daisy chain.

In exemplary operation, the register bus master 402 may initiate a request (not shown) to program a hardware register 410(0)-410(15) of one of the processor modules 404(0)-404(15). As non-limiting examples, the request to program the hardware register 410(0)-410(15) may comprise a request to read a hardware register value and/or to write a value to a hardware register. As such, the request to program the hardware register 410(0)-410(15) may include information required for carrying out the request, such as an address. The request may also be accompanied by additional data, such as a data value to be written to a register and/or a data valid indicator. The request may be initiated by the register bus master 402 in response to an instruction (not shown) of software 318 of FIG. 3, as a non-limiting example.

The request is then passed via the pipelined register bus 400 to the register bus slave 408(0) of the processor module 404(0) connected to the register bus master 402. The register bus slave 408(0) extracts the address of the request, and forwards it to the module core 406(0) for processing. The address is then decoded by the module core 406(0), and evaluated to determine whether the address corresponds to the processor module 404(0) (e.g., whether the address falls within an address space associated with the processor module 404(0)). If the address does not correspond to the processor module 404(0), the register bus slave 408(0) of the processor module 404(0) forwards the same request as-is to the register bus slave 408(1) of the next processor module 404 in the daisy chain (in this example, the processor module 404(1)).

However, if the address is determined to correspond to the processor module 404(0), the request is processed by the module core 406(0) to program the hardware register 410(0)-410(15). In some aspects, processing the request to program the hardware register 410(0)-410(15) may comprise writing a data value accompanying the request to the hardware register 410(0)-410(15), and/or outputting a response from the hardware register 410(0)-410(15) to the pipelined register bus 400. The register bus slave 408(0) of the processor module 404(0) then forwards the same request as-is to the register bus slave 408(1) of the next processor module 404 in the daisy chain (in this example, the processor module 404(1)) along with a result, if any, of the processing of the request. It is to be understood that the forwarding of the same request and the corresponding result, if any, to the next processor module 404 in the daisy chain occurs at a same processor clock cycle (not shown).

To illustrate exemplary communications flows within a register bus slave for providing a pipelined register bus, FIGS. 5A-5C are provided. FIGS. 5A-5C show a processor module 500, which according to some aspects may correspond to one of the processor modules 404(0)-404(15) of FIG. 4. In particular, FIG. 5A illustrates the processor module 500 receiving a request to program a hardware register from a register bus master via a register bus. FIG. 5B shows processing of the request, while FIG. 5C illustrates the request and a response, if any, being output to the register bus.

As seen in FIG. 5A, the processor module 500 includes a module core 502, which provides processing functionality for the processor module 500. In particular, the module core 502 comprises an address decoder 504, a programmable hardware register 505, a read register 506, and a read data validity indicator 508. The operations of the aforementioned elements of the module core 502 are discussed in greater detail below.

The processor module 500 further includes a register bus slave 512 for communicating via a register bus 514. In the example of FIGS. 5A-5C, the processor module 500 has a processing latency of two (2) clock cycles. Accordingly, the register bus slave 512 of the processor module 500 includes bus interfaces 516(0)-516(X), each of which receives a data clock signal 518 from a data clock source 520. It is to be understood that the number of bus interfaces 516 corresponds to a processing latency of the processor module 500. For instance, in aspects wherein the processor module 500 has a processing latency of three (3) processor clock cycles, the bus interface 516(1) may be provided. In the example of FIGS. 5A-5C, the processor module 500 has a processing latency of two (2) processor clock cycles, and thus the bus interface 516(1) is not required, and is omitted from FIGS. 5B and 5C for the sake of clarity. According to some aspects, the processing latency of the processor module 500 may depend in whole or in part on the number of clock cycles required by the address decoder 504 to decode an address.

The bus interfaces 516(0)-516(X) include respective request registers 522(0)-522(X) for communicating a request 524 via the register bus 514. The bus interfaces 516(0)-516(X) also include respective data registers 526(0)-526(X) for receiving a data value 528 from the register bus 514, and respective data validity indicator registers 530(0)-530(X) for receiving a data validity indicator 532 corresponding to the data value 528 from the register bus 514. In addition, the bus interface 516(X) further includes logical OR gates 534 and 536, the operation of which is described in greater detail below.

In FIG. 5A, the request 524, which has been initiated by a register bus master such as the register bus master 402 of FIG. 4, is passed by the register bus 514 to the bus interface 516(0) of the register bus slave 512. In some aspects, the request 524 comprises a request to program a hardware register such as the hardware register 505 of the module core 502. The request 524 includes an address 538 of the targeted hardware register, and may further include a write enable indicator 540 and/or a read enable indicator 542 indicating whether the request to program the hardware register 505 is a write request and/or a read request, respectively. In the case of a write request, the data value 528 may be set by the register bus master 402 with a data value to be written, while the data validity indicator 532 may be set to one (1) to indicate that the data value is valid. For read requests, the data value 528 and the data validity indicator 532 may both be set to zero (0) by the register bus master 402.

Referring now to FIG. 5B, the bus interface 516(0) of the register bus slave 512 forwards the request 524, the data value 528, and the data validity indicator 532 to the module core 502. The bus interface 516(0) also passes the same request 524 as-is, along with the data value 528 and the data validity indicator 532, to the bus interface 516(X). In the module core 502, the address 538 of the request 524 is extracted. The module core 502 then determines whether the address 538 of the request 524 corresponds to the processor module 500. As a non-limiting example, the module core 502 may determine whether the address 538 falls within an address space assigned to the processor module 500, such as an address of the hardware register 505.

FIG. 5C illustrates the results of the module core 502 determining whether the address 538 corresponds to the processor module 500. If the address 538 does not correspond to the processor module 500, the request 524 is passed on as-is by the bus interface 516(X) of the register bus slave 512 to the register bus 514. In some aspects, the module core 502 may output a value of zero (0) to the logical OR gates 534 and 536 when the address 538 does not correspond to the processor module 500, and/or if the request 524 represents a write operation. By outputting the value of zero (0) to the logical OR gates 534 and 536, the original values of the data value 528 and the data validity indicator 532 may pass through the register bus slave 512 unchanged as a response 544 and an output data validity indicator 546.

If the address 538 does correspond to the processor module 500, the request 524 is processed by the module core 502 according to whether the write enable indicator 540 and/or the read enable indicator 542 of the request 524 are set. If the write enable indicator 540 is set, the module core 502 may write the data value 528 of the request 524 to the hardware register 505 indicated by the address 538. Because the write operation is complete when the data value 528 is written to the hardware register 505, the latency of the write operation may be calculated as the sum of the individual latencies of the processor module 500 and any preceding processor modules (not shown) that receive and pass along the request 524 prior to the processor module 500.

If the read enable indicator 542 is set, the module core 502 may read a value of the hardware register 505 indicated by the address 538, and output the value of the hardware register 505 to the logical OR gate 534 of the bus interface 516(X) via the read register 506. The module core 502 may also read a value of the read data validity indicator 508, and output the value of the read data validity indicator 508 to the logical OR gate 536 of the bus interface 516(X). According to some aspects, the data value 528 and the data validity indicator 532 passed into the register bus slave 512 in FIG. 5A are both set to zero (0) when the read enable indicator 542 is set. Thus, the response 544 that is output from the logical OR gate 534 of the bus interface 516(X) has the value of the read register 506, while the output data validity indicator 546 that is output from the logical OR gate 536 has the value of the read data validity indicator 508. The response 544 and the output data validity indicator 546 are output by the register bus slave 512 to the register bus 514, to be passed to a subsequent processor module (not shown) or to the register bus master 402 of FIG. 4, if the processor module 500 is the last processor module on the register bus 514. Because the read operation is not complete until the response 544 reaches the register bus master 402, the latency of the read operation may be calculated as the sum of the individual latencies of the processor module 500 and every other processor module (not shown) on the register bus 514.

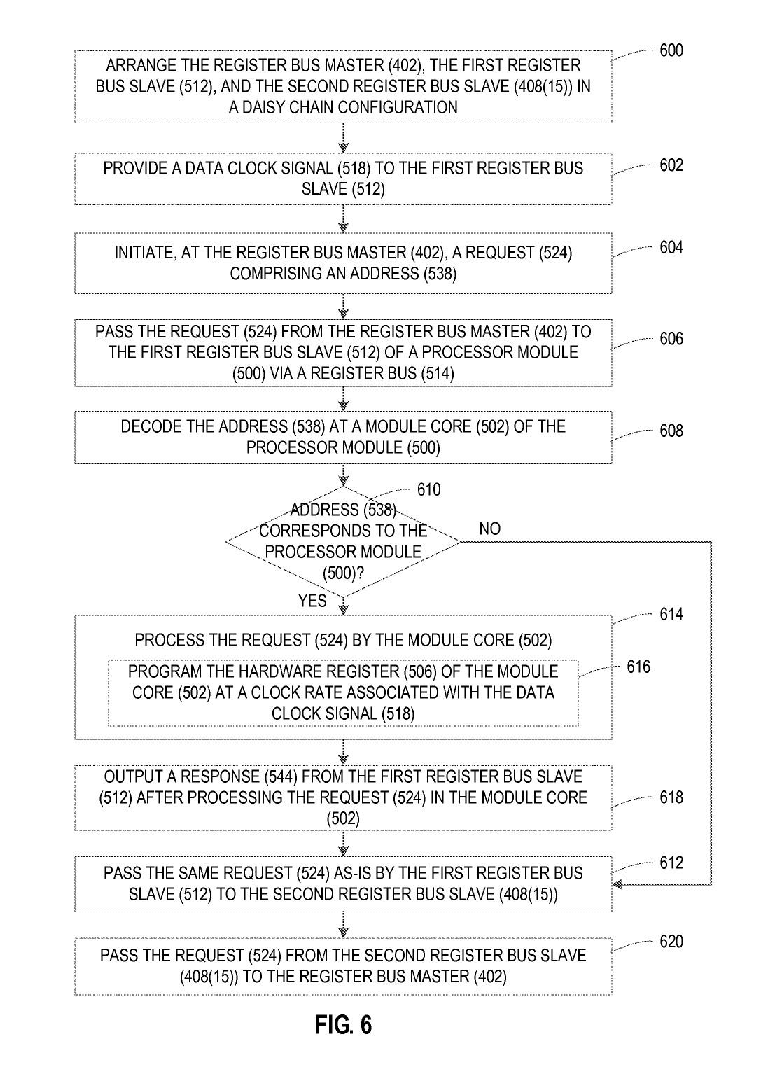

FIG. 6 is a flowchart provided to illustrate an exemplary process for communicating over the pipelined register bus 400 of FIG. 4. In describing FIG. 6, elements of FIGS. 4 and 5A-5C are referenced for the sake of clarity. In FIG. 6, operations begin with the register bus master 402, a first register bus slave 512, and a second register bus slave 408(15) being arranged in a daisy chain configuration in some aspects (block 600). A data clock signal 518 may be provided to the first register bus slave 512 (block 602).

A request 524 comprising an address 538 is then initiated at the register bus master 402 (block 604). The request 524 is passed from the register bus master 402 to a first register bus slave 512 of a processor module 500 via a register bus 514 (block 606). The address 538 of the request 524 is next decoded at a module core 502 of the processor module 500 (block 608). The module core 502 then determines whether the address 538 corresponds to the processor module 500 (block 610). If not, the first register bus slave 512 passes the same request 524 as-is to the second register bus slave 408(15) (block 612).

However, if the module core 502 determines at decision block 610 that the address 538 corresponds to the processor module 500, the request 524 is processed by the module core 502 (block 614). In some aspects, operations of block 614 for processing the request 524 may include programming the hardware register 505 of the module core 502 at a clock rate associated with the data clock signal 518 (block 616). The first register bus slave 512 may then output a response 544 after processing the request 524 in the module core 502 (block 618). The request 524 may then be passed from the second register bus slave 408(15) to the register bus master 402 (block 620).

Programming hardware registers using a pipelined register bus according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for communicating over a register bus, comprising:
initiating, at a register bus master, a request comprising an address;
passing the request from the register bus master to a first register bus slave of a processor module via a register bus;
decoding the address at a module core of the processor module;
determining whether the address corresponds to the processor module;
responsive to determining that the address corresponds to the processor module:
processing the request by the module core; and
passing the same request as-is by the first register bus slave to a second register bus slave; and
responsive to determining that the address does not correspond to the processor module, passing the same request as-is by the first register bus slave to the second register bus slave.

2. The method of claim 1, wherein the request further comprises an instruction to program a hardware register of the module core.

3. The method of claim 1, further comprising arranging the register bus master, the first register bus slave, and the second register bus slave in a daisy chain configuration.

4. The method of claim 3, further comprising passing the request from the second register bus slave to the register bus master.

5. The method of claim 2, further comprising providing a data clock signal to the first register bus slave.

6. The method of claim 5, further comprising programming the hardware register of the module core at a clock rate associated with the data clock signal.

7. The method of claim 1, further comprising outputting a response from the first register bus slave after processing the request in the module core.

8. A system for communicating over a register bus, comprising:
a register bus communicatively coupling a register bus master to a first register bus slave of a processor module, and further communicatively coupling the first register bus slave to a second register bus slave;
the register bus master configured to:
initiate a request comprising an address; and
pass the request to the first register bus slave of the processor module via the register bus;
the processor module configured to:
decode the address at a module core of the processor module;
determine whether the address corresponds to the processor module; and
responsive to determining that the address corresponds to the processor module:
process the request by the module core; and
the first register bus slave configured to pass the same request as-is by the first register bus slave to the second register bus slave via the register bus.

9. The system of claim 8, wherein the register bus master is configured to initiate the request further comprising an instruction to program a hardware register of the module core.

10. The system of claim 8, wherein the register bus master, the first register bus slave, and the second register bus slave are arranged in a daisy chain configuration.

11. The system of claim 10, wherein the second register bus slave is configured to pass the request to the register bus master via the register bus.

12. The system of claim 9, further comprising a data clock source configured to provide a data clock signal to the first register bus slave.

13. The system of claim 12, wherein the first register bus slave is further configured to program the register of the module core at a clock rate associated with the data clock signal.

14. The system of claim 8, wherein the first register bus slave is further configured to output a response to the register bus after the module core processes the request.

15. An apparatus comprising a register slave device on a register bus, the register slave device comprising:
a first bus interface configured to receive a request from a register bus;
an address decoder communicatively coupled to the first bus interface, the address decoder configured to:
extract an address from the request; and
decode the address;
a second bus interface communicatively coupled to the first bus interface, the second bus interface configured to pass the request from the first bus interface back to the register bus; and
a module core communicatively coupled to the first bus interface and configured to process the request.
